(19) United States
(12) Patent Application Publication
(10) Pub. No.: US 2014/0238907 A1
(43) Pub. Date: Aug. 28, 2014

(54) APPARATUS AND METHOD FOR SEPARATING NUTS OF DIFFERENT BUOYANCY IN A LIQUID

(71) Applicant: Mohammad NAKHEI-NEJAD, Edmonton (CA)

(72) Inventor: Mohammad NAKHEI-NEJAD, Edmonton (CA)

(21) Appl. No.: 14/192,211

(22) Filed: Feb. 27, 2014

Related U.S. Application Data
(60) Provisional application No. 61/770,086, filed on Feb. 27, 2013.

(51) Int. Cl. B03B 5/28

(52) U.S. Cl. CPC B03B 5/28
USPC 209/606

(57) ABSTRACT

An apparatus and method for separating nuts of different buoyancy in a liquid. The apparatus has a tank, a support frame, and a particle collecting device. The particle collecting device has a shell that is attached to and wraps circumferentially around an auger shaft that is rotatably mounted to the support frame. As the auger shaft is rotated about its axis, the attached shell is rotated in the liquid in the tank and its spiral shape directs nuts onto the auger shaft, and the auger surface advances the nuts towards an end opening of the shell disposed outside of the tank.

### FIELD OF THE INVENTION

The present invention relates to an apparatus and method for separating nuts of different buoyancy in a liquid.

### BACKGROUND OF THE INVENTION

Many nuts comprise shells which presents handling and processing issues. Pistachio nuts comprise a greenish edible seed, enclosed within a hard, straw-colored shell (endocarp), enclosed in turn within a fleshy, green, outer hull (pericarp). Some pistachio nuts on a pistachio tree have seeds that fully fill their shells within intact hulls. Other pistachio nuts have empty shells or seeds that only partially fill the shell. Other pistachio nuts still may be so called “early split” pistachio nuts having split hulls, which are susceptible to contamination with carcinogenic fungal aflatoxins.

Commercially saleable pistachio nuts ideally consist only of pistachio nuts having seeds that fully fill their shells, obtained from intact hulls. However, it is impractical to selectively harvest such pistachio nuts in commercial operation. A common harvesting method is to use shaking equipment that indiscriminately shakes pistachio nuts off a pistachio tree resulting in a mixture of pistachio nuts having empty or partially filled shells, and early split pistachio nuts, as well as possibly leaves and fragments of bark and branches.

Accordingly, there is a need in the art for an apparatus of separating different qualities of nuts, such as pistachio nuts. The apparatus is preferably suitable for processing commercial quantities of pistachio nuts at a high rate, operable in an automated manner, and simple and economical to construct and maintain.

### SUMMARY OF THE INVENTION

Different types of nuts may be separated from each other by their buoyancy in water. For example, pistachio nuts with seeds that fully fill their shells within intact hulls typically have a specific gravity greater than unity and negative buoyancy in water. Pistachio nuts with sufficiently empty shell volume may have neutral or positive buoyancy in water. Early split pistachio nuts tend to prematurely dehydrate and as their moisture content decreases, these pistachio nuts will tend towards neutral buoyancy in water.

In one aspect, the present invention relates to an apparatus for collecting nuts floating at a buoyant depth in a liquid, the apparatus comprising:

(a) a collection tank for the liquid, and having a lower collection trough;

(b) a first rotating scoop positioned to scoop nuts at a first depth in the tank;

(c) a second rotating scoop positioned to scoop nuts at a second depth in the tank;

(d) a conveyor for removing nuts which sink to the lower collection trough;

(e) a first lateral conveyor disposed within the first scoop for removing nuts scooped by the first scoop; and

(f) a second lateral conveyor disposed within the second scoop for removing nuts scooped by the second scoop.

In one embodiment, the first and second lateral conveyor comprises an auger comprising a rotating helical blade, or flighting, which may be disposed within a shell which acts as the scoop. The shell wraps circumferentially around the auger shaft from a shell fixed end attached to the auger shaft to a scooping edge, wherein the shell defines a shell end opening exposing an end of the auger shaft and a shell circumferential opening exposing an intermediate portion of the auger shaft. The scooping edge is disposed away from the auger shaft to define a shell passage leading to the shell circumferential opening. The shell is shaped so that, as the shaft central axis is substantially horizontal and the auger shaft is rotated about the central axis to rotate the shell, scooping edge periodically rotates through the buoyant depth, the shell directs the nuts from the shell end, through the shell passage, through the circumferential opening and onto the auger shaft. The auger shaft advances the nuts toward the shell end opening, as the shaft central axis is substantially horizontal and the auger shaft is rotated about the central axis.

In one embodiment of the device, the shell has a plurality of perforations sized to permit the passage of the liquid therethrough.

In one embodiment of the device, each of the scoops comprises a substantially cylindrical shell having a longitudinal opening defined by a scooping edge. The cylindrical shell may have a spiral shape curving concavely around the auger shaft towards the scooping edge, and may have an increasing radius of curvature towards the scooping edge. The first and second lateral conveyors may be disposed within the cylindrical shell of the first and second scoop, respectively. Further, the first and second lateral conveyors may be attached to the first and second scoop, respectively, so as to rotate in unison.

In one embodiment, the first and second lateral conveyors comprise an auger or auger shaft.

In one embodiment, the first and second scoop define a flow path from the first scoop to the second scoop, wherein the device further comprises a first and second barrier, wherein the first and second barrier are sized to accumulate nuts at or above the first and second depths in the tank, respectively, wherein the first barrier is disposed in the flow path between the first and second scoops, and wherein the first barrier is disposed in the flow path in front of the second scoop. The barriers may be curved concavely towards the flow path. The first and second scoops are shaped to induce a current in the liquid in the direction of the flow path when rotated.

In one embodiment of the device, the device further comprises a first extension tube attached to the first scoop and having an inlet disposed to receive nuts from the first lateral conveyor and an outlet disposed away from the collection tank, and a second extension tube attached to the second scoop and having an inlet disposed to receive nuts from the second lateral conveyor and an outlet disposed away from the collection tank. The extension tubes may be supported circumferentially by a plurality of rollers rotatably connected to a support frame. The first and second lateral conveyor may extend into the first and second extension tube, respectively.

In one embodiment, the collection tank comprises a weir at the level of the first tank depth.

In one embodiment, the conveyor may comprise a bucket elevator having a terminal end disposed within the collection tank. The bucket elevator may comprise a bucket having perforations sized to allow the liquid but not nuts to pass therethrough and a conveyor trough disposed below the bucket to collect the liquid and inclined towards the tank to return the liquid to the collection tank. Further, the collection tank may have a bottom surface that is downwardly inclined towards the terminal end of the bucket elevator.

In one embodiment, the conveyor may comprise a looped chain, a means for driving the chain in the loop, a perforated trough disposed below the looped chain to selectively permit the passage of liquid therethrough but not nuts, and a plurality of plates projecting from the chain to urge nuts along the perforated trough as the chain is driven in the loop,

In another aspect, the invention may comprise a method of sorting nuts based on buoyancy in a liquid, the method comprising the steps of:

(a) Depositing nuts in a collection tank filled with a liquid;

(b) Collecting floating nuts with a first rotating scoop positioned to scoop at a first depth in the tank;

(c) Collecting nuts with an intermediate buoyancy with a second rotating scoop positioned to scoop at a second depth in the tank; and

(d) Collecting nuts which do not float with a conveyor positioned the bottom of the tank.

In one embodiment, the first rotating scoop also moves the floating nuts laterally out of the first scoop, and the second rotating scoop also moves the intermediate buoyancy nuts laterally out of the second scoop.

### BRIEF DESCRIPTION OF THE DRAWINGS

In the drawings, like elements are assigned like reference numerals. The drawings are not necessarily to scale, with the emphasis instead placed upon the principles of the present invention. To the extent that the drawings are of specific embodiments or a particular use of the invention, they are intended to be illustrative only, and not limiting of the claimed invention. The drawings are briefly described as follows.

FIG. 1 is a side view of one embodiment of the apparatus of the present invention.

FIG. 2 is a top view of one embodiment of the apparatus of the present invention.

FIG. 3 is a side view of the tank of the present invention.

FIG. 4 is a side view of the particle collecting devices of the present invention.

FIG. 5 is a top view of one embodiment of the apparatus of the present invention.

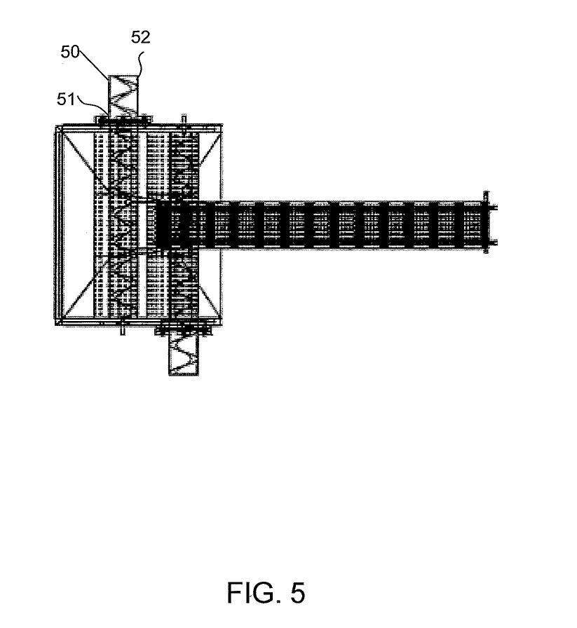

FIG. 6 is a side vide of one embodiment of the present invention showing one embodiment of the conveyor as a chain conveyor.

FIGS. 7A and 7B are a top view and side view, respectively, of the chain conveyor shown in FIG. 6. FIG. 7C is a detailed view of the bottom end of the chain conveyor shown in FIG. 7B. FIG. 7D is a detailed view of the bottom end of the chain conveyor shown in FIG. 7A.

### DETAILED DESCRIPTION OF PREFERRED EMBODIMENTS

The present invention relates to an apparatus and method for separating nuts of different buoyancy in a liquid. When describing the invention, any term or expression not expressly defined herein shall have its commonly accepted definition understood by those skilled in the art. To the extent that the following description is of a specific embodiment or a particular use of the invention, it is intended to be illustrative only, and not limiting of the claimed invention.

As used herein, the term “buoyant depth” shall refer, in the context of a particle floating within a liquid, the distance between the surface of the liquid and the particle, it being understood that the vertical dimension of the particle is insignificant relative to its buoyant depth. As used herein, the term “tank depth” shall refer, in the context of a particle floating within a liquid in a tank, the distance between the surface of the tank and the particle, it being understood that the vertical dimension of the particle of is insignificant relative to its buoyant depth.

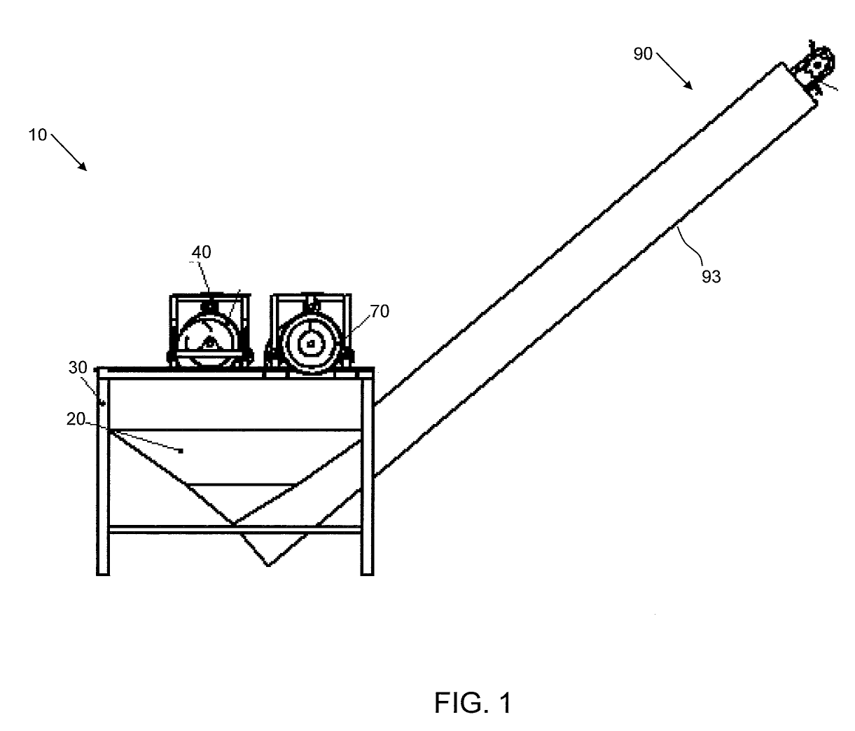

In one aspect, the present invention provides an apparatus for separating nuts of different buoyancy in a liquid. Referring to the embodiment of the apparatus shown in FIG. 1, the apparatus (10) generally comprises a tank (20), a support frame (30), a first rotating scoop (40), a second rotating scoop (70), and a conveyor (90). In embodiments, the apparatus (10) further comprises a first barrier (60) and second barrier (100). The parts of the apparatus (10) may be made of any material having sufficient strength and durability and as needed, corrosion resistance to the liquid. Suitable materials may include, without limitation, metal, plastic, and fiberglass.

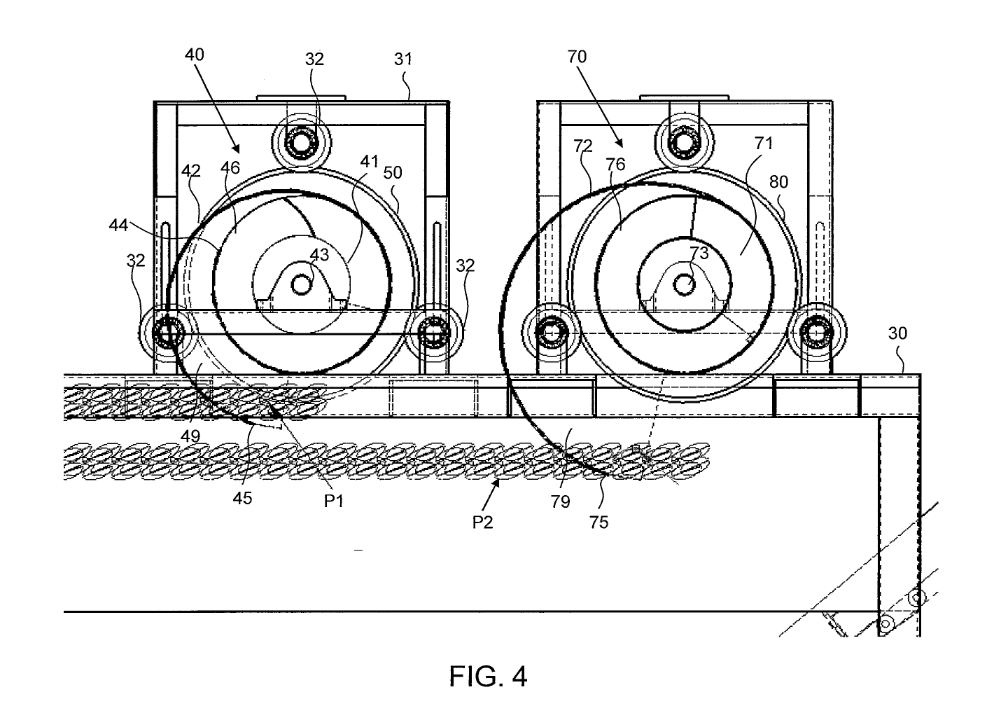

The tank (20) may comprise any structure suitable for containing the liquid and the nuts in the liquid. In one embodiment shown in FIGS. 1 and 4, the tank (20) has an open top (21) and a bottom surface (22) that slopes downwardly from the open top (22) towards a collection trough at the bottom of the tank. The terminal end (94) of the conveyor is disposed in or near the collection trough. In other embodiments, not shown, the tank (20) may have a closed top. In one embodiment, the tank (20) has a tank opening (23) at a first tank depth.

The support frame (30) may comprise any structure suitable to which the first auger shaft (41) of the first scoop (40) and the second auger shaft (71) of the second scoop (70) may be rotatably mounted. In one embodiment, as shown in FIG. 1, the support frame (30) also supports the tank (20).

As best shown in FIG. 4, the first scoop (40) generally comprises a first auger shaft (41), a first shell (42), and a means for rotating the first auger shaft. The first auger shaft (41) has a substantially horizontal first shaft central axis (43). As used herein, the term “auger shaft” refers to any shaft having a surface defining a series of helix curves around its shaft central axis. The auger shaft (41) is rotatably mounted to the support frame (30) for rotating about the first shaft central axis (43). In particular, the auger shaft (41) may be rotatably mounted to the support frame (30) by bearings (not shown) at one end of the auger shaft (41).

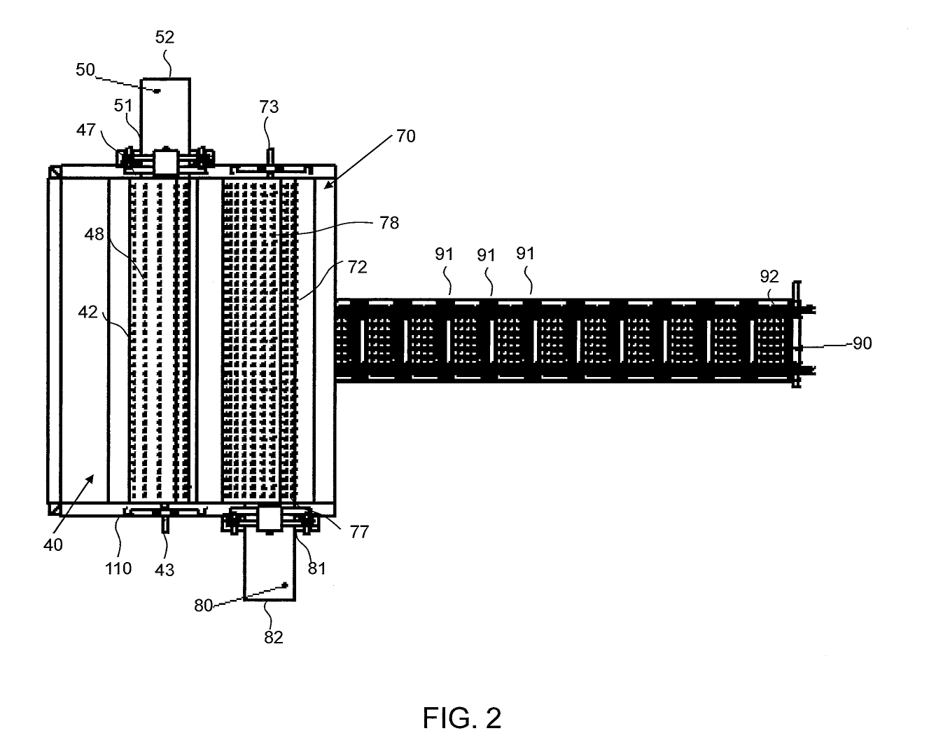

As best shown in FIG. 4, the first shell (42) wraps circumferentially around the first auger shaft (41) from a first shell fixed end (44) to a first scooping edge (45). As shown in FIG. 2, the shell defines a first shell opening (47) that exposes an end of the first auger shaft (41). As shown in FIG. 4, the shell also defines a first shell circumferential opening (46) that exposes an intermediate portion of the first auger shaft (41). The first scooping edge (45) is disposed away from the first auger shaft (41) to define a first shell passage (49) leading the first shell circumferential opening (46). In one embodiment as shown in FIG. 4, the first shell (42) curves convexly around the first auger shaft (41) towards the first scooping edge (45). In particular, the first shell (42) has an increasing radius of curvature towards the first scooping edge (45), to form the scoop. Further, as best seen in FIG. 2, the first shell (42) has a plurality of perforations (48) that are sized to permit the liquid to pass therethrough.

In one embodiment, as best shown in FIGS. 2 and 4, the device (10) further comprises a first extension tube (50). The first extension tube (50) has a first tube inlet (51) which is attached to the first shell (42) to align the first shell end opening (47) and the first tube inlet (41). The extension tube (50) also has a first tube outlet (52). The support frame (30) has a portion (31) to which a plurality of rollers (32) are rotatably mounted. The rollers (32) are positioned on the circumference of the first extension tube (50) to support the first extension tube (50) and permit rotation of the first auger shaft (41) about the first shaft central axis (43). It will be appreciated that in this manner, the first shell end opening (47) is unobstructed. In one embodiment, first auger shaft (41) does not extend beyond the first the first tube inlet (51). In one embodiment, as shown in Figure, 5, the first auger shaft (41) may extend into the extension tube (50), and may extend as far as the first tube outlet (52).

The means for rotating the first auger shaft about the first shaft central axis (43) may comprise any suitable means known in the art. As a non-limiting example, the means may comprise an electric motor. It will be understood that the means for rotating the auger shaft may be in direct driving engagement with the auger shaft (41) itself, or in indirect driving engagement through the shell (42) or other part attached to the auger shaft (41).

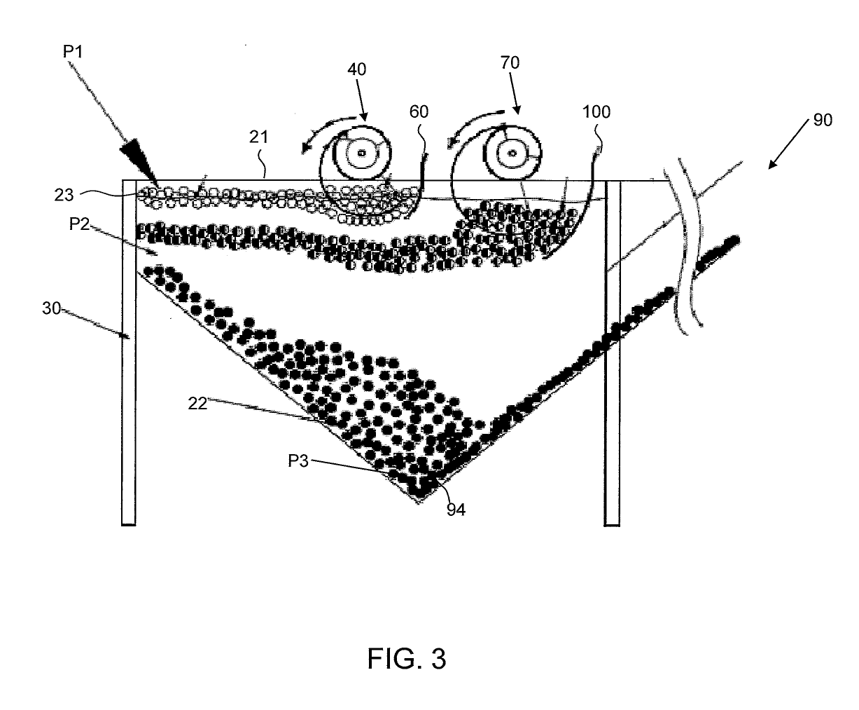

As shown in FIG. 3, the first barrier (60) is disposed adjacent the first scoop (40) in a flow direction, which is shown from left to right in FIG. 3. The barrier (60) is positioned at a depth to accumulate nuts floating at the first tank depth, which facilitate collection of the nuts by the first scoop (40). In one embodiment, as shown in FIG. 3, the first barrier (60) is constructed of a planar element that is positioned across the tank (20) and curved convexly towards the first particle collecting device (40). As may be seen, liquid flow across the tank causes nuts floating at or near the top of the liquid to accumulate in front of the first barrier (60), facilitating collection by the rotating first scoop (40).

As shown in FIG. 3, in one embodiment, the second scoop (70) is disposed behind the first barrier (60) in the flow direction. The second scoop (70) may generally be of identical or similar construction as the first scoop, but be configured to collect nuts at a lower depth, either by fitting a larger shell, or by being positioned lower in the tank. In one embodiment, the second scoop comprises a second auger shaft (71), a second shell (72), means for rotating the second auger shaft, a second extension tube (80), and a second barrier (100).

As shown in FIG. 4, the first scoop (40) is configured so that the first scooping edge (45) periodically rotates through a first tank depth, and the second scoop (70) is configured so that the second scooping edge (75) periodically rotates through a second tank depth that is greater than the first tank depth. In one embodiment, this is accomplished by making the radius of curvature of the second shell (72) larger than the radius of curvature of the first shell (42) while the first auger shaft (41) and the second auger shaft (71) are of the same size and disposed at the same elevation, above the first tank depth.

The conveyor may, in one embodiment, comprise a bucket elevator (90) which comprises a plurality of buckets (91) attached to a chain (92), a means to drive the chain, and a conveyor trough (93) disposed beneath the buckets (91). The buckets have perforations sized to allow the liquid to pass therethrough on to the conveyor trough (93) below. The conveyor trough (93) is inclined towards the tank (20) so that the liquid flows along the conveyor trough (93) back to the tank (20).

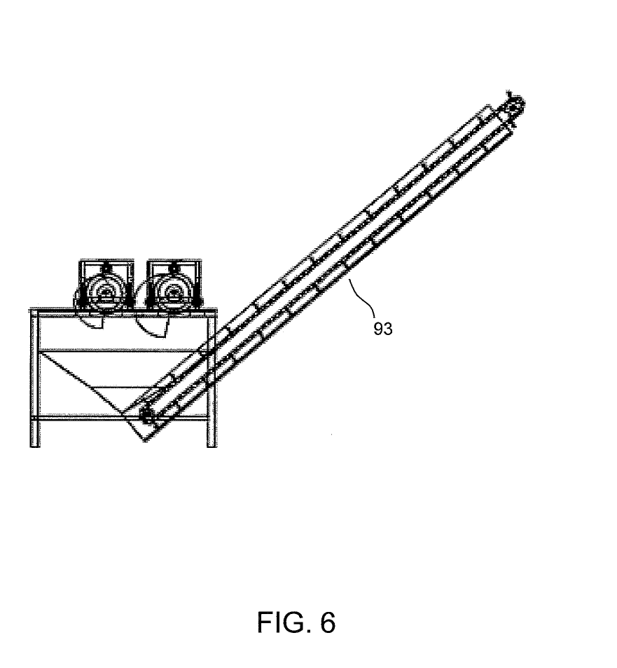

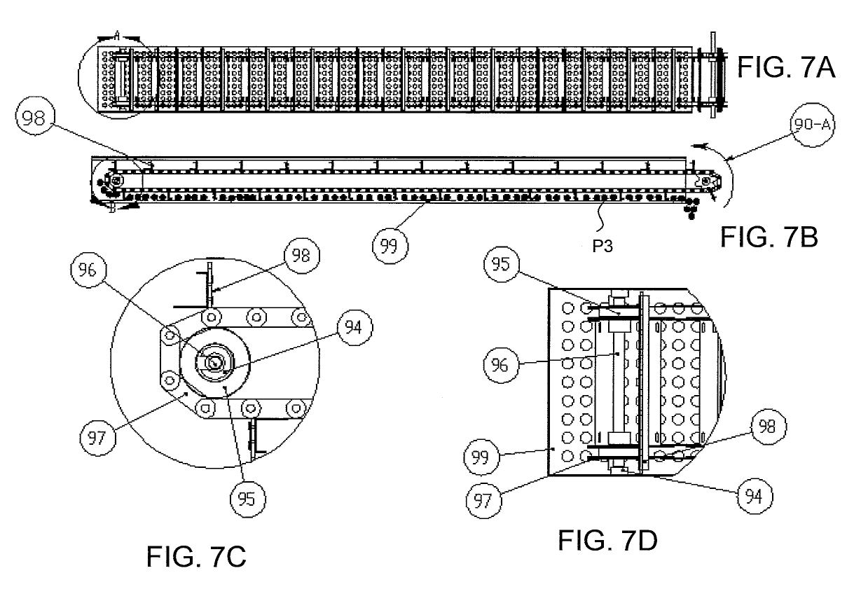

In one embodiment, as shown in FIGS. 6 and 7A to 7D, the conveyor may comprise a chain conveyor. The chain conveyor comprises a roller type chain (97), sprockets (95), a plurality of plates (98), and a perforated trough (99). It will be noted that none of the components of the chain conveyor are immersed within the liquid in the tank (20). In one embodiment, the plates (98) may be made of a corrosion resistant material. The chain (97) is looped around sprockets (95). The plurality of plates (98) is connected to the chain (97) in a spaced apart fashion and such that the plates project outwardly from the chain (97).

The use and operation of the apparatus (10) is now described in an example to separate are a mixture of empty shell pistachio nuts (P1) having positive buoyancy, early-split pistachio nuts (P2) having neutral buoyancy, and pistachio nuts with full shells and intact hulls (P3) having negative buoyancy, in water.

The tank (20) is first filled with water. When the level of the water reaches the level of the tank opening (23) at the first tank depth, the water will flow out of the tank (20) by means of a weir, thereby limiting and keeping constant the level of water in the tank (20).

The means for rotating the first auger shaft, the means for rotating the second auger shaft and the means to drive the chain are energized to commence rotation of the first auger shaft (41), the second auger shaft (71) and the chain (92), respectively.

The mixture of nuts (P1, P2, P3) is then discharged through the top opening (21) into the tank (20) at one end of the tank (20). As a result of their differing buoyancies in water, the empty shell pistachio nuts (P1) float on the surface of the water at the first tank depth, the early-split pistachio nuts (P2) submerge in the water at the second tank depth, and the pistachio nuts with full shells and intact hulls (P3) sink to the bottom surface (22) of the tank (20).

Referring to FIG. 3, the means for rotating the first auger shaft causes the first auger shaft (41) and the attached first shell (42) to repeatedly rotate in unison in a counter-clockwise direction. Referring to FIG. 4, as the first shell (41) rotates through a single cycle, the first scooping edge (45) rotates downwardly through the first tank depth and induces a current in the water urging the nuts (P1) in a forward flow direction from left to right. However, the first barrier (60) is sized to prevent the flow of nuts (P1), but not nuts (P2), in the flow direction. As the first scooping edge (45) rotates downwardly through the first tank depth, it also collects any of the nuts (P1) in its vicinity. As the first scooping edge (45) rotates upwardly, the spiral shape of the first shell (42) directs the collected nuts through the first shell passage (49) towards the first shell circumferential opening (46) and onto the first auger shaft (41), while the perforations (48) permit the water to drain back to the tank (20). The curved shape of the first barrier (60) assists the movement of the nuts (P1) into the first shell (41) because nuts (P1) impinged against the first barrier (60) will tend to flow both downwards and back towards the first shell (42) as the first shell free edge (45) begins its upward assent. Referring to FIG. 2, as the first auger shaft (41) rotates, its auger surface advances the collected nuts (P1), in a tumbling fashion, towards and through the first shell end opening (47), the first tube inlet (51) and the first tube outlet (52). The nuts (P1) may be collected at the first tube outlet (52) for further processing, or the first tube outlet (52) may deposit the collected nuts (P1) onto another processing machine (not shown).

Referring to FIG. 3, the means for rotating the second auger shaft causes the second auger shaft (71) and the attached second shell (72) to repeatedly rotate in unison in a counter-clockwise direction. Referring to FIG. 4, as the second shell (71) rotates through a single cycle, the second scooping edge (75) rotates downwardly through the second tank depth and induces a current in the water urging the nuts (P2) in a forward flow direction from left to right. However, the second barrier (100) prevents the further passage of the nuts (P2) in the flow direction. As the second scooping edge (75) rotates downwardly through the second tank depth, it also collects any of the nuts (P2) in its vicinity. As the second scooping edge (75) rotates upwardly, the spiral shape of the second shell (72) directs the collected nuts towards the second shell passage (79) towards the second shell circumferential opening (76) and onto the second auger shaft (71), while the perforations (78) permit the water to drain to the tank (20). The curved shape of the second barrier (100) assists the movement of the nuts (P2) into the second shell (71) because nuts (P2) impinged against the barrier (100) will tend to flow both downwards and back towards the second shell (42) as the second scooping edge (75) begins its upward assent. Referring to FIG. 2, as the second auger shaft (71) rotates, its auger surface advances the collected nuts (P2), in a tumbling fashion, towards and through the second shell end opening (77), the second tube inlet (81) and the second tube outlet (82). The nuts (P2) may be collected at the second tube outlet (82) for further processing, or the second tube outlet (82) may deposit the collected nuts (P2) onto another processing machine (not shown).

Referring to FIG. 3, in the case where the conveyor (90) is a bucket elevator, the nuts (P3) slide along the inclined bottom surface (22) along the collection trough towards the terminal end (94) of the conveyor (90) bucket elevator. The water collected by the buckets (91) drains through the perforations in the bucket (91) and runs back through the conveyor trough (93) towards the tank (20). The nuts (P3) are collected by the buckets (91) at the terminal end (94) of the bucket elevator (90) and conveyed out of the tank (20) towards an upper terminal end where they may be deposited in a container, for further processing. Referring to FIG. 7A to 7D, in the case where the conveyor is a chain conveyor, the sprockets (95) are rotated in a counter-clockwise direction in reference to FIG. 7B to drive the chain (97) in a loop. As the plates (98) past through the lower half of the loop, they urge the nuts (P3) upwardly along the perforated trough (99). Any liquid adhering to the nuts (P3) will tend to flow downward through the perforations of the trough (99) and returned to the tank (20).

It will be understood that this example is non-limiting, and that the apparatus (10) may be scaled to separate different types of nuts in different types of liquids. It will be understood that different liquids may be selected or that the density of the liquid may be selectively altered (e.g., by the addition of a solute) so that the density of the liquid is intermediate to the different densities of the nuts to be separated, thereby causing the nuts to have different buoyancies in the liquid.

As will be apparent to those skilled in the art, various modifications, adaptations and variations of the foregoing specific disclosure can be made without departing from the scope of the invention as defined by the claims herein.

What is claimed is:

1. A device for sorting nuts based on buoyancy in a liquid, the device comprising:
(a) a collection tank for the liquid, and having a lower collection trough;
(b) a first rotating scoop positioned to scoop nuts at a first depth in the tank;
(c) a second rotating scoop positioned to scoop nuts at a second depth in the tank;
(d) a conveyor for removing nuts which sink to the lower collection trough;
(e) a first lateral conveyor disposed within the first scoop for removing nuts scooped by the first scoop; and
(f) a second lateral conveyor disposed within the second scoop for removing nuts scooped by the second scoop.

2. The device of claim 1 wherein each of the first and second scoops defines a plurality of perforations permitting the passage of the liquid therethrough, but not nuts.

3. The device of claim 1 wherein each of the first and second scoops comprises substantially a cylindrical shell having a longitudinal opening defined by a scooping edge.

4. The device of claim 3 wherein each of the cylindrical shells has a spiral shape with an increasing radius of curvature towards the scooping edge.

5. The device of claim 3 wherein the first and second lateral conveyors are disposed within the cylindrical shell of the first and second scoop, respectively.

6. The device of claim 5 wherein the first and second lateral conveyors are attached to the cylindrical shell of the first and second scoop, respectively, so as to rotate in unison.

7. The device of claim 1 wherein each of the first and second lateral conveyors comprises an auger or auger shaft.

8. The device of claim 1 wherein the first and second scoop define a flow path from the first scoop to the second scoop, wherein the device further comprises a first and second barrier, wherein the first and second barrier are sized to accumulate nuts at or above the first and second depths in the tank, respectively, wherein the first barrier is disposed in the flow path between the first and second scoops, and wherein the first barrier is disposed in the flow path in front of the second scoop.

9. The device of claim 8 wherein the barriers are curved concavely towards the flow path.

10. The device of claim 8 wherein the first and second scoops are shaped to induce a current in the liquid in the direction of the flow path when rotated.

11. The device of claim 1 further comprising a first extension tube attached to the first scoop and having an inlet disposed to receive nuts from the first lateral conveyor and an outlet disposed away from the collection tank, and a second extension tube attached to the second scoop and having an inlet disposed to receive nuts from the second lateral conveyor and an outlet disposed away from the collection tank.

12. The device of claim 11 wherein the first and second lateral conveyor extend into the first and second extension tube, respectively.

13. The device of claim 11 further comprising a support frame and a plurality of rollers rotatably connected to the support frame, wherein the plurality of rollers circumferentially support the first and second extension tubes.

14. The device of claim 1 wherein the collection tank comprises a weir at the level of the first tank depth.

15. The device of claim 1 wherein the conveyor comprises at least one bucket for collecting nuts.

16. The device of claim 15 wherein the at least one bucket having perforations sized to permit the passage of liquid therethrough, but not nuts.

17. The device of claim 16 wherein the conveyor further comprises a conveyor trough disposed below the at least one bucket, wherein the conveyor trough is inclined to return the liquid to the collection tank.

18. The device of claim 1 wherein the conveyor comprises a looped chain, a means for driving the chain in the loop, a perforated trough disposed below the looped chain to selectively permit the passage of liquid therethrough but not nuts, and a plurality of plates projecting from the chain to urge nuts along the perforated trough as the chain is driven in the loop.

19. A method of sorting nuts based on buoyancy in a liquid, the method comprising the steps of:
(a) Depositing nuts in a collection tank filled with a liquid;
(b) Collecting floating nuts with a first rotating scoop positioned to scoop nuts at a first depth in the tank;
(c) Collecting nuts with an intermediate buoyancy with a second rotating scoop positioned to scoop nuts at a second depth in the tank; and
(d) Collecting nuts which do not float with a conveyor positioned at the bottom of the tank.

20. The method of claim 19 wherein the first rotating scoop also moves the floating nuts laterally out of the first scoop, and the second rotating scoop also moves the intermediate buoyancy nuts laterally out of the second scoop.
